(19) United States
(12) Patent Application Publication
(10) Pub. No.: US 2019/0241159 A1
(43) Pub. Date: Aug. 8, 2019

(54) CAR WASH APPARATUS

(71) Applicant: Kurt SCHUSTER, Utica, MI (US)

(72) Inventor: Kurt SCHUSTER, Utica, MI (US)

(21) Appl. No.: 15/888,384

(22) Filed: Feb. 5, 2018

(51) Int. Cl. B60S 3/04; B08B 3/02

(52) U.S. Cl. CPC B60S 3/04; B08B 3/02

(57) ABSTRACT

According to the present disclosure, an apparatus for washing a car associated with a garage is disclosed. The apparatus is configured to be coupled a c-shaped rail of a garage door. The apparatus has a compressor configured to pressurize a container holding a fluid. The fluid is forced through a hose and though a plurality of nozzles. The plurality of nozzles are coupled to brackets which are fixed to the c-shaped rails.

### FIELD

The present disclosure relates to a car wash apparatus and more particularly to an apparatus for washing a car that couples to a garage door structure.

### BACKGROUND

This section provides background information related to the present disclosure that is not necessarily prior art.

Car aficionados often desire to regularly clean their cars. To reduce expense, these car owners often clean their vehicles at home. There is a need to improve car wash equipment for home use.

### SUMMARY

This section provides a general summary of the disclosure, and is not a comprehensive disclosure of its full scope or all of its features.

According to the present teachings, an apparatus for washing a car associated with a garage is disclosed. The apparatus is configured to be coupled a c-shaped rail of a garage door. The apparatus has a compressor configured to pressurize a container holding a fluid. The fluid is forced through a hose and though a plurality of nozzles. The plurality of nozzles are coupled to brackets which are fixed to the c-shaped rails.

According to another teaching, the apparatus contains a first and a second fluid containing containers. The first and second fluid containing containers are coupled to the aforementioned hose by a selective switch.

According to another teaching, the apparatus contains a pressure limiting switch between compressor and the fluid containing container.

According to another teaching, the apparatus is configured to allow the garage to open and close.

According to another teaching, the apparatus is configured to spray liquid in a direction away from the building.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 represents a car wash apparatus according to the present teachings;

FIG. 2 represents a front view of the compressor and fluid supply;

FIGS. 3A-3D represents views of the nozzle and brackets shown in FIG. 1;

FIGS. 4A and 4B represent bracket members for coupling the nozzles to the c-shaped rail members.

Corresponding reference numerals indicate corresponding parts throughout the several views of the drawings.

### DETAILED DESCRIPTION

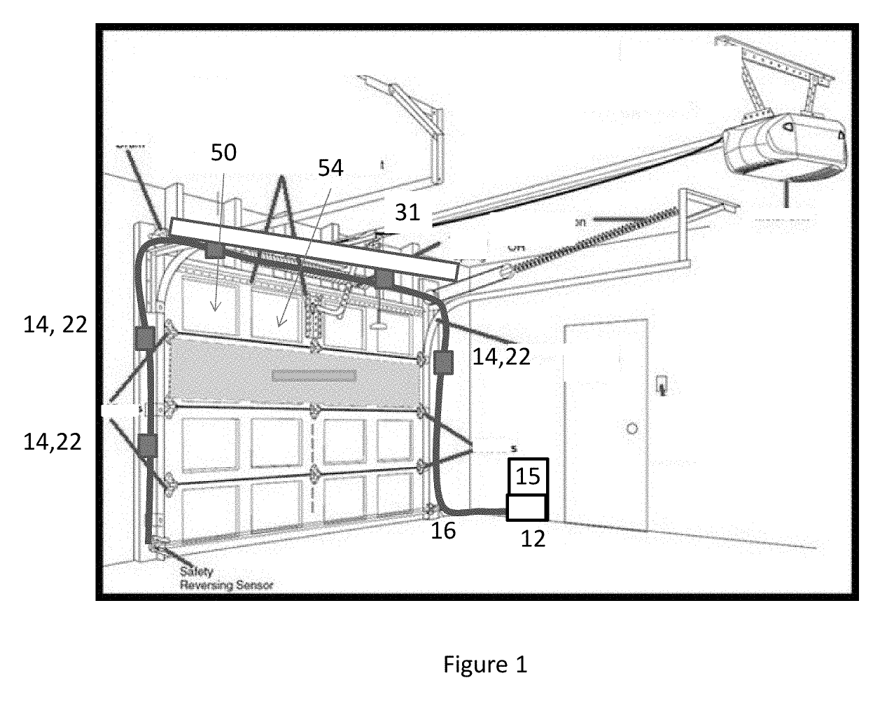

Example embodiments will now be described more fully with reference to the accompanying drawings. With reference to FIGS. 1 through 4B, shown is a car wash 10 according to the present teachings. FIG. 1 discloses a car wash 10 which has a compressor and fluid supply 12, nozzles 14, and a member or hose 16 carrying fluid from a vehicle cleaning fluid supply 18. As is known, the nozzles 14 are configured to couple to a spray cleaning fluids onto the top and sides of the vehicle.

The car wash apparatus 10 is positioned adjacent to the opening 50 of a vehicle garage. As shown, a garage door 52 is positioned at this opening 50. The door 54 is supported by a drum and coil spring assembly which can be lifted by a lift mechanism 56. The door's weight is supported by a c-shaped track or rail

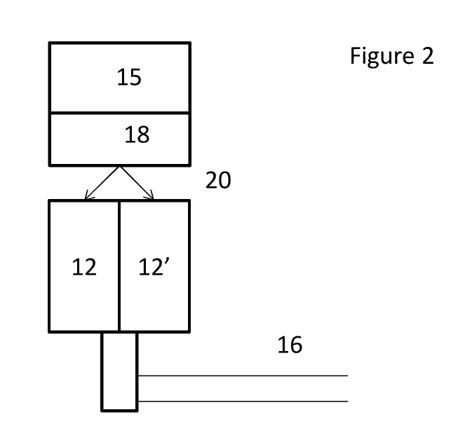

FIG. 2, represent a perspective view of the compressor and fluid supply 12. The compressor 15 and fluid supply 12 has a housing 21 defining the compressed air supply 18 and an air output 20, and associated air pressure regulator valve 23. The compressor and fluid supply 12 has a hose coupling 26 coupled to the nozzles 14. The fluid supply 12 can have first and second chambers 12′, 12″ that can hold different cleaning fluids. For example, the first chamber 12′ contain clean deionized water, or surfactant containing water. While the second chamber can contain water soluble car wax. As high pressure air comes in from the vehicle cleaning fluid supply 12 liquid is forced through the nozzles and onto the car which can be slowly driven out of or into the garage opening.

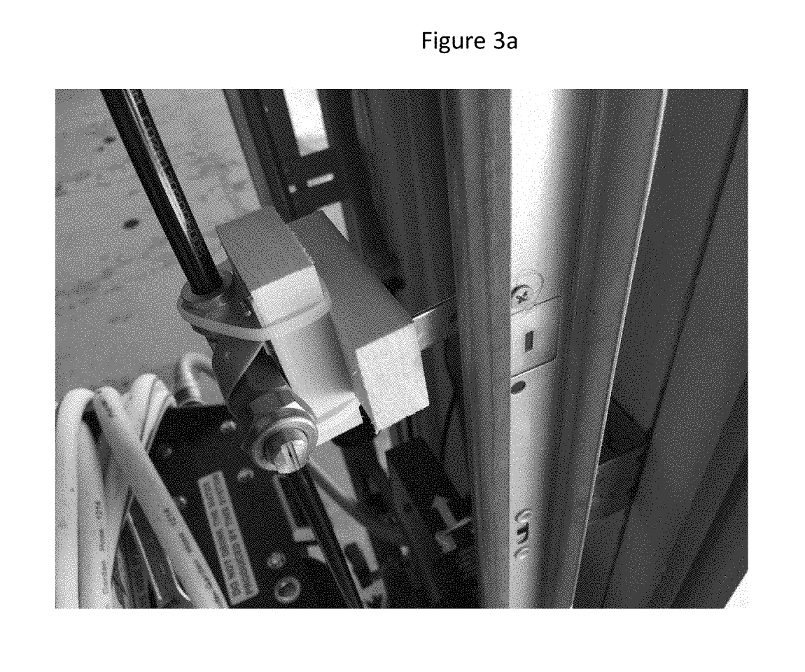

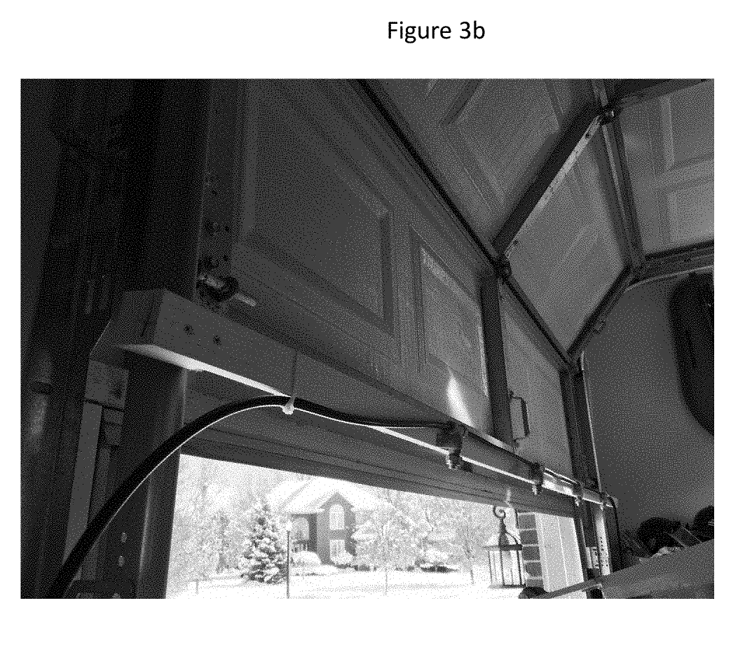

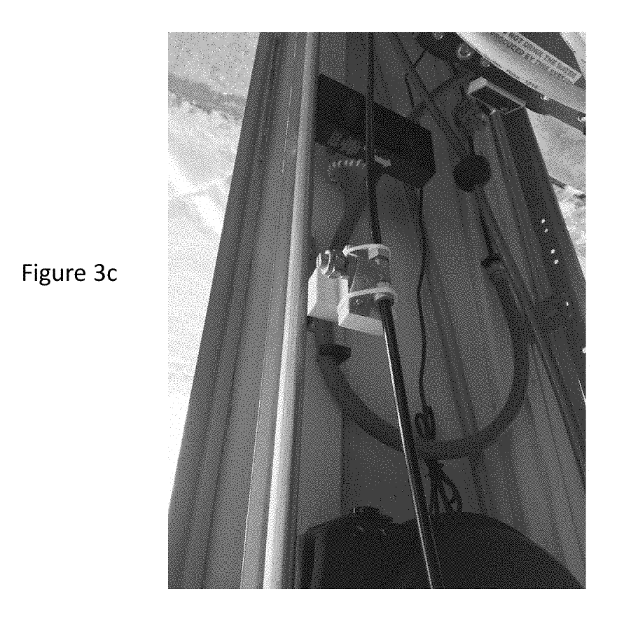

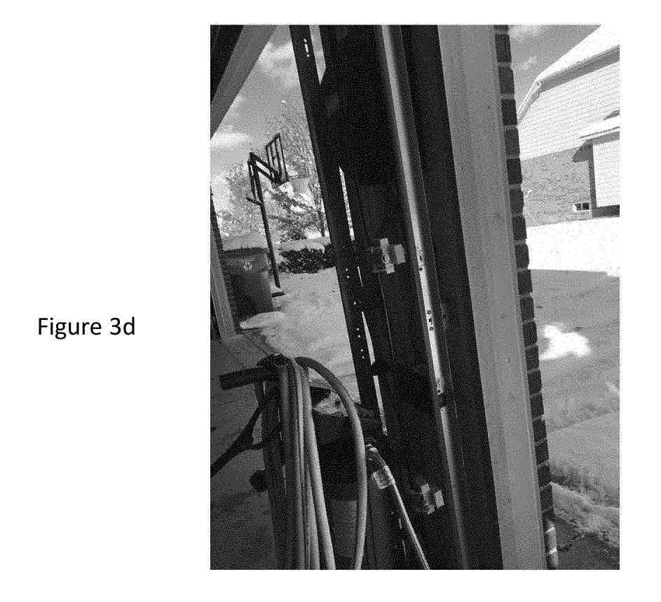

As shown in FIGS. 3a-3d, the nozzles and associate brackets 22 shown in FIG. 1 are disposed radially about a garage entrance 31. Optionally, the nozzles disposed above the door opening can be supported by a cross beam 60 which is positioned above the door 54. The air pressure causes fluid to flow from the fluid supply 12 through the hose and nozzles 14. Generally, the fluid from the nozzle 14 can be sprayed between 30 and 45 degrees away from the vehicle.

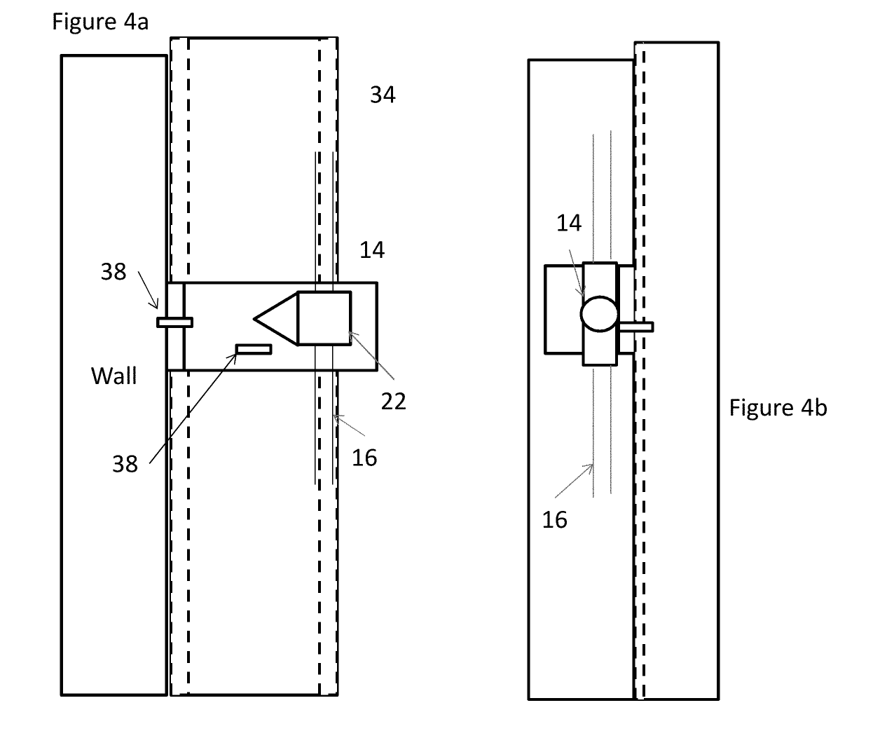

FIGS. 4A and 4B represent front and side bracket members for coupling the nozzles to the c-shaped rail members 34. As can be seen, the brackets are configured to interface with the c-shaped rail members 34 in a manner that will allow the opening and closing of the garage door without the disengagement of the brackets.

The brackets 22 can be formed of stainless steel, or polymer. Optionally the brackets 22 bearing surface 24 can have a high friction material such as neoprene to increase the friction between the brackets 22 and the c-shaped rail 34 using a fastener such as a screw or bolt 38. In addition to the bearing surfaces 24, the brackets 22 also defines a pair of inner surfaces 27 that engage the c-shaped rail 34, that align the nozzles in a proper orientation.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A washing for a car associated with a garage comprising:
a garage door including a pair of c-shaped garage door rails;
a plurality of brackets coupled to the c-shaped garage door rails, each bracket having an associated nozzle;
a hose coupled to each associated nozzle;
a fluid supply coupled to the hose; and
a compressed air supply coupled to the fluid supply.

2. The apparatus according to claim 1 comprising a pressure regulator disposed between the compressed air supply and the fluid supply.

3. The apparatus according to claim 1 wherein the fluid is forced through a hose and though a plurality of nozzles.

4. The apparatus according to claim 1 wherein the fluid supply comprises a first and a second fluid containing containers.

5. The apparatus according to claim 4 wherein the first and second fluid containing containers are coupled to the hose by a selective switch.

6. A washing for a car associated with a garage door including a pair of c-shaped garage door rails comprising:
a plurality of brackets disposed adjacent to the c-shaped garage door rails, each bracket having an associated nozzle;
a hose coupled to each associated nozzle;
a fluid supply coupled to the hose; and
a compressed air supply coupled to the fluid supply.

7. The apparatus according to claim 1 comprising a pressure regulator disposed between the compressed air supply and the fluid supply.

8. The apparatus according to claim 1 wherein the fluid is forced through a hose and though a plurality of nozzles.

9. The apparatus according to claim 1 wherein the fluid supply comprises a first and a second fluid containing containers.

10. The apparatus according to claim 4 wherein the first and second fluid containing containers are coupled to the hose by a selective switch.
